(19) United States
(12) Patent Application Publication
(10) Pub. No.: US 2014/0299657 A1
(43) Pub. Date: Oct. 9, 2014

(54) CARDBOARD BOX FOR BAKERY

(71) Applicant: Michele Giudilli, Mattinata (FG) (IT)

(72) Inventor: Michele Giudilli, Mattinata (FG) (IT)

(21) Appl. No.: 14/355,675

(22) PCT Filed: Nov. 2, 2012
(86) PCT No.: PCT/IB2012/056101

§ 371 Date: May 1, 2014

(30) Foreign Application Priority Data
Nov. 2, 2011 (IT) FG2011A000009

(51) Int. Cl. B65D 5/60; B31B 7/00

(52) U.S. Cl. CPC B65D 5/603; B31B 7/00; B31B 2217/0069
USPC 229/164.2; 493/63

(57) ABSTRACT

A box for bakery foodstuffs and preferably for pizza, realized in recyclable material, characterized in that it comprises at least a sheet of impermeable material and suitable to come in contact with foodstuffs, said sheet being constrained such that it can be tore away manually from the portion of said box on which said bakery foodstuffs are leaned. Once the pizza in consumed, the invention allows the sheet to be removed and the cardboard to be suitable to be recycled, since it is free of organic substances, such as liquid and solid residues of the pizza.

### RELATED APPLICATIONS

This application is the U.S. National Stage under 35 USC 371 of PCT Application PCT/IB2012/056101.

### BACKGROUND OF THE INVENTION

1. Field of the Invention

The present invention relates to a recyclable cardboard box for foodstuffs, for example bakery foodstuffs.

In particular, the present invention can be advantageously used to contain, as a way of example, pizzas, hot focaccias or similar bakery foodstuffs and to allow their comfortable transportation and subsequent consumption.

2. Brief Description of the Prior Art

At the state of the art, there are known boxes for the foodstuffs transport, and in particular for the transport of pizzas, which are generally provided in corrugated cardboard. The corrugated cardboard boxes commonly used for such an aim, even if realized in cardboard, are not recyclable because of the pizza organic residues (oil, fat, sauce, cheese), with which they come in contact during the consumption, which usually occurs using the same boxes.

This aspect is very problematic from an ecologic point of view since these cardboard boxes go generally in the undifferentiated waste collection and when, by mistake they end up in the containers for the recyclable paper, they risk to contaminate and to create problems in the recycle step. For example, only in the United States, for this reason, every year more than 3 billion pizza boxes end up in the undifferentiated collection, and become a serious ecological problem both for their disposal and the impossibility to recycle said cardboard. On the containers for the differentiated collection of paper and cardboard is in fact indicated that it is expressly forbidden to throw paper and cardboard containing organic residues. At the state of the art, there are known some solutions for this problem, which however, are not generally addressed to the usage of disposable boxes as the cardboard ones, but rather to the usage of steel boxes (like the Pi-Pan re-usable steel system), or other materials which however are disadvantageous because they are very expensive and require that the box has to be re-delivered and washed every time.

The present invention is not to be confused with other inventions known in the art as the case of the document US20010072197 to Gary Neff et al. In this document it is shown a cardboard box suitable for the microwave cooking, comprising aluminum sheets or portions of aluminum sheets or other material apt to act as “susceptor”, i.e. able to absorb the electromagnetic waves produced by the microwave oven and to re-output the same energy as thermal/infrared radiation in order to roast and to make crispy certain foodstuffs cooked or warmed up in these boxes suitable for microwave ovens. In these boxes the “susceptor” sheet is glued by means of coupling on the whole surface, without being possible to remove it simply.

### SUMMARY OF THE INVENTION

Therefore, aim of the present invention is to provide a recyclable box for foodstuffs, and in particular for pizza, realized in corrugated cardboard; according to another aspect the present invention provides a recyclable box for bakery foodstuffs, and in particular for pizza, which can be used with high hygienic standard for the consumption of the same as well.

Moreover, the present invention provides a method for the production of a corrugated cardboard recyclable box for bakery foodstuffs.

### BRIEF DESCRIPTION OF THE DRAWINGS

These and other advantages will be clear thanks to the detailed description, which will refer to the appended drawings, Ia, Ib, Ic, 2a, 2b, 2c, 3a, 3b, 3c, 4, 5, 6a, 6b and 6c, 7a, 7b, 8a, 8b, 9a, 9b described in detail in the following.

### DETAILED DESCRIPTION OF THE PREFERRED EMBODIMENTS

As it is shown in figure Ia, the invention comprises a box for foodstuffs (10, 20), which can be variously shaped as it is better described in the following, realized in corrugated cardboard or other disposable material which comprises a sheet (11, 21) of paper suitable for the contact with hot foodstuffs and impermeable to liquids. For example, said sheet (11, 21) can be realized in greaseproof paper, paraffined paper or baking paper. For baking paper is preferably intended paper of “parchment vegetable paper” type produced by means of mechanical and chemical methods or only by mechanical methods. Said paper can be mono- or bi-siliconed, i.e. it can have a silicone layer on one or both sides. Without limiting, according to the aims of the present invention, it can be preferably used mono-siliconed baking paper, conveniently positioned so that it turns the siliconed side to the foodstuffs, and whose non-siliconed side can be printed using inks compatible for the foodstuff usage.

The siliconed paper sheet (11, 21) of square, circular, rectangular shape or other shape according to the shape of the foodstuffs box (10, 20) with which it is to be used, is glued to said box (10, 20) by means of one or more gluing points (16, 23), which are preferably positioned at the corners of said sheet (11). It is clear that the sheet of impermeable material is glued to the portion of the box (10, 20) on which the foodstuff is leaned. Referring for example to a box (10) for pizza, which has the typical square or rectangular shape, the sheet (11) is conveniently glued by means of gluing points (16) to the side (A) of the box on which the pizza (17) can be leaned.

Said sheet (21) can possibly have perforations (22) to make easier the tearing away at the corners or points (16, 23) where there is the glue which couples the sheet to the cardboard box. In this way, when someone has eaten the pizza (17, 24) using the box (10, 20) as a support, according to the present invention, can simply tear away the paper sheet (11, 21), or, when there are perforations (22), tear it away from the glued corners having the perforations, curl it up and finally throw it away in the undifferentiated waste, while the box (10, 20) for pizza is not contaminated by organic residues and can be disposed in a container for the paper to be recycled, thus realizing the aim of the present invention.

When it is realized the embodiment which provides the usage of the perforation (22), the points in which the sheet is glued to the cardboard, after the tearing away, remain in the cardboard but not represent recyclability problems since the probability that they are dirtied are very low and the glue used does not represent problems of recyclability.

Without departing from the aims of the present invention, the sheet (11, 21) can be realized in greaseproof paper, baking paraffined paper or every other paper apt to be in hot contact with the foodstuffs which has anti-adherence and non-absorbing properties. In this way, fats and oils can be removed by removing the sheet and they are prevented from ending on the cardboard, thus dirtying the bottom. The result is that it is possible to dispose a very cleaner cardboard and foodstuff residues free in the containers for the paper disposal, with respect to a cardboard without this solution.

As yet said, according to the present invention together with the box (10) it can be used a paraffined, greaseproof or baking paper sheet (11) of the just described type, however apt to the aim without perforations, glued in the same way as the solution providing the perforation usage, i.e. the points of glue arranged at the corners or in other points without impairing the effectiveness and the aims of the present invention. In fact, given the features of the corrugated cardboard and of the lower side of the baking paper, by using a glue with low gluing power, it is possible to remove the sheet from the bottom without the perforations as well. Said sheet (11) will be tore away from the glue points (16) with a simple action, and will be curled up leaving the cardboard bottom intact and clean. Moreover, by using baking paper of the “parchment” type, the sheet resists also to the cutting of the pizza in slices by means of the “pizza roller cutter”, without the sheet being tore with consequent oil and fat leakage.

As said, an aim of the present invention is to make more hygienic and safer the pizza consumption in the take away cardboard boxes, thus improving the same pizza consumption directly from the box. The usage of a sheet configured according to what just described allows to have a pizza box more hygienic than the box without it, which are known at the state of the art. In fact, it is prevented that the mozzarella or the fused cheese can come in contact with the cardboard, and therefore cause unpleasant effects of “gluing” of the stringy cheese with the cardboard. Moreover, the impermeability of the additional paper sheet allows to eat the pizza directly from the box as a classical dish, thanks to the capability of the additional sheet to retain liquids and fats.

Another problem solved by this invention is that some producers of pizza cardboard use, whether consciously or not, corrugated cardboards produced not with pure virgin cellulose as according to the sanitary regulations, but which contain partially or totally cellulose and fibres coming from wastepaper or sometimes contaminated paper. This contaminated paper or not in virgin cellulose, being exposed to high temperatures in contact with the pizza can release harmful substances possibly contained therein. However, regardless the quality of the cellulose with which the cardboard is realized, by using the present invention, there is a major hygienic safety than what allowed by the boxes known at the state of the art, which is guaranteed by the additional sheet in baking paper. The additional baking sheet provided by this invention offers more safety to the consumer preventing the direct, contact with the cardboard. So, it is clear how the usage of this sheet allows to have a safer box for pizza in corrugated cardboard and a more hygienic consumption of the pizza, in addition to make recyclable the same boxes. The invention is applied also to the so called “cube” cardboards, which are cardboards for pizza which do not have a closing cover (indicated by the letter B in the drawings), but which are opened upwards in order to allow more cardboards of the same type (“cube”) to be stacked, thus making easier the transport of more pizzas. In this case the sheet is arranged in the same way as the standard cardboard with cover, and has the same features and the same effectiveness in terms of recyclability and hygiene.

According to another embodiment of the present invention, in order to improve further the hygienic aspect, another sheet (34) of the same shape and material as the first one, possibly smaller in dimensions than the first sheet (31) can be arranged on the cover (B) of the cardboard, which is at the side of the same when in open position. When the cardboard (30) is closed, said second sheet (34) arranged on the cover (B) of the cardboard is in the lower portion of the same cover. Aim of this second sheet is to prevent that the inner portion of the cover (B) of the cardboard comes in contact with the pizza condiments, like it usually occurs both for the collapse of the central portion of the cardboard and for the numerous condiments of the pizzas which make them taller. By adding a second sheet this problem is advantageously prevented, thus increasing the integrity of the product to be consumed. This second sheet, when of smaller dimension than the first sheet (31) arranged on the bottom of the box, is compatible with the praxis of numerous producers of pizza cardboards to provide holes (36) on the cover (B) of the cardboard (30) apt to make the vapour released by the hot pizza go away, which otherwise by condensing can reduce the fragrance and the integrity of the pizza.

In fig. Ia it is shown the first embodiment of the invention with a cardboard for pizza (10) comprising a first surface (A) constituting the bottom of the cardboard and which is in contact with the lower side of the pizza when the cardboard is closed, and a second surface (B) constituting the cover of the pizza box, when the same is closed by means of folding flaps (12, 13, 14 and 15). A paraffined or baking sheet (11) is glued by means of gluing points (16), preferably but non exclusively arranged in the corners, by means of glue of quantity and quality apt to guarantee an average adherence, but which is simply removable according to the aim of the present invention and apt to the use in the foodstuff packaging.

In fig. Ib, it is shown a top view of the box in the side (A), with the pizza (17) in the typical position of consumption of the same. The pizza rests on the sheet (11), allowing a more hygienic consumption and preventing that the bottom A of the cardboard (10) is dirtied or contaminated. In fig. Ic it is shown a view with the cardboard (10) half-opened in which it is shown a hand (18) when removes a flap (19) from each corner of the sheet, after the consumption of the pizza.

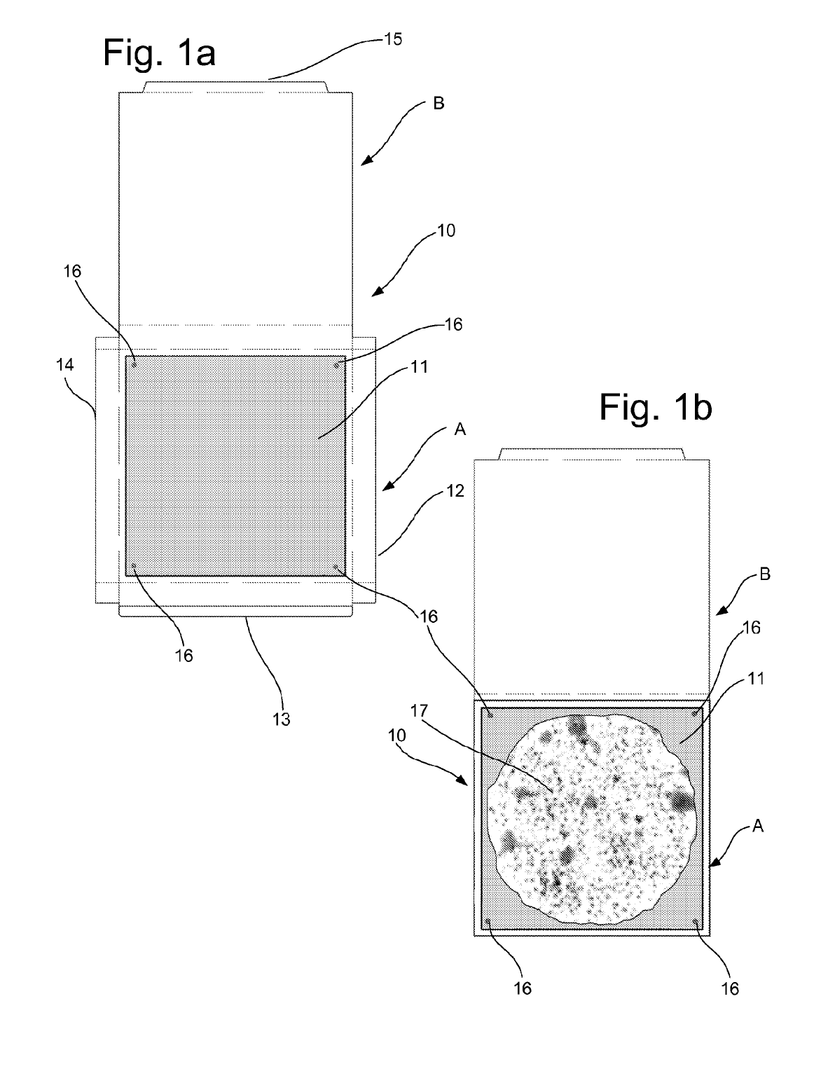

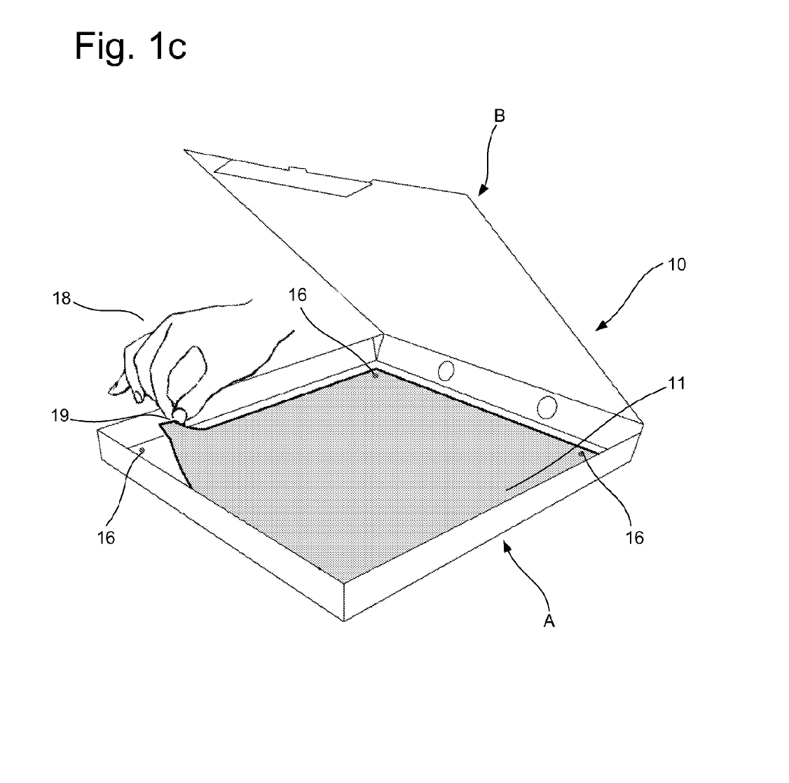

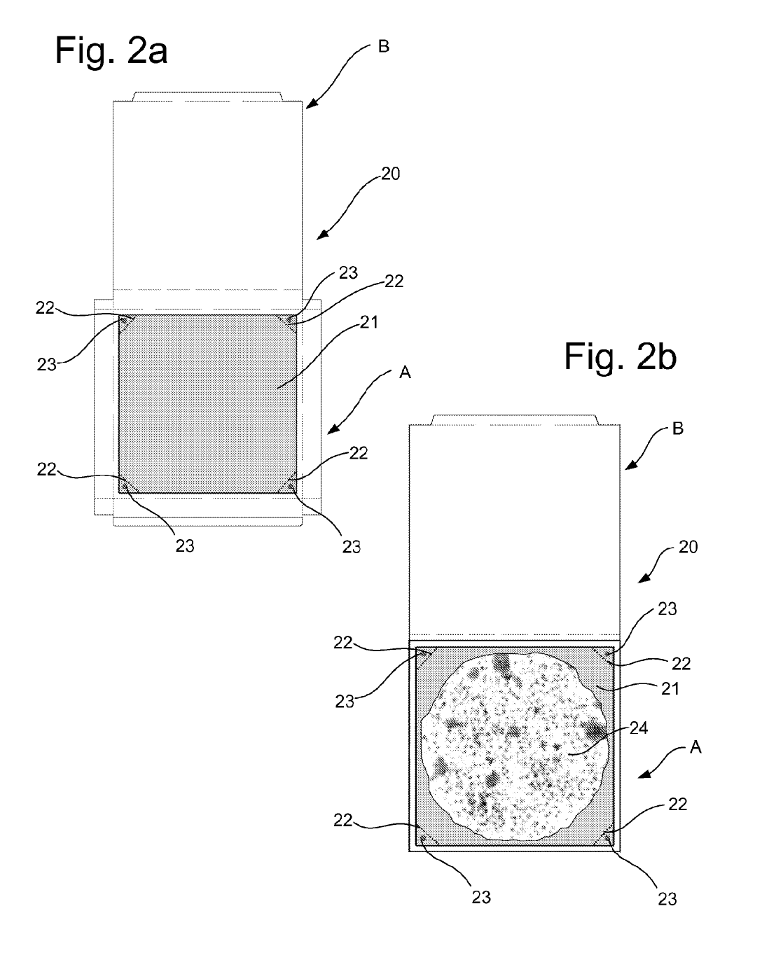

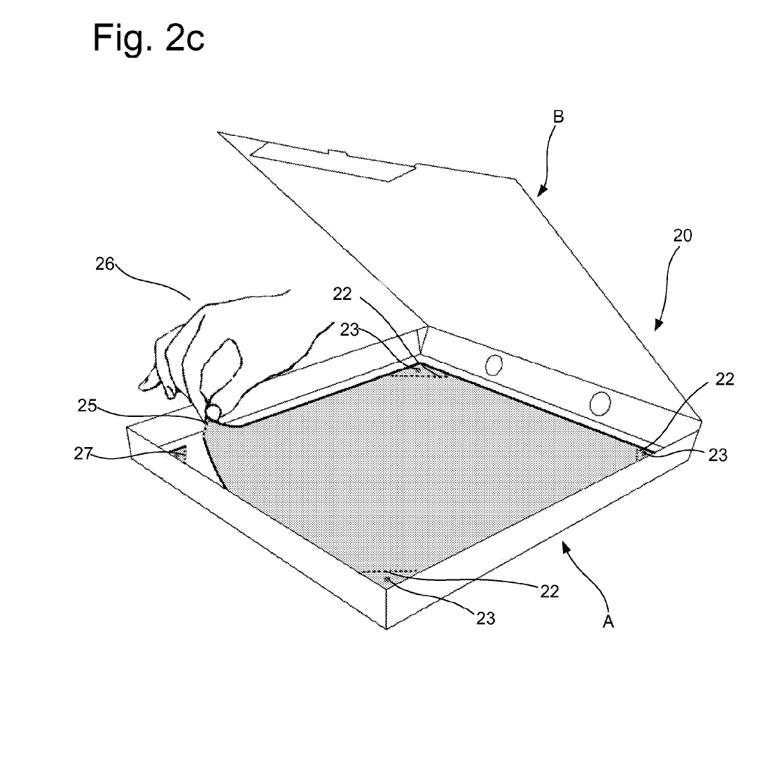

In FIG. 2a it is shown a second embodiment, in which on the cardboard for pizza (20) it is glued a sheet (21) of baking paper by means of glue points (23) arranged at the four corners of the sheet (21) and at which it is provided a point perforation (22) apt to facilitate the tearing away of the sheet, in order to remove it more practically. In FIG. 2b it is shown the cardboard (20) with the perforation (22) at the corners of said sheet (21), with the pizza (24) in the position for the consumption of the same. In FIG. 2c, there are shown the effects of the perforation, which consist in that when a hand (8) tears away the edge (25), the glued portion (27) remains integral in the side (A) of the cardboard (20).

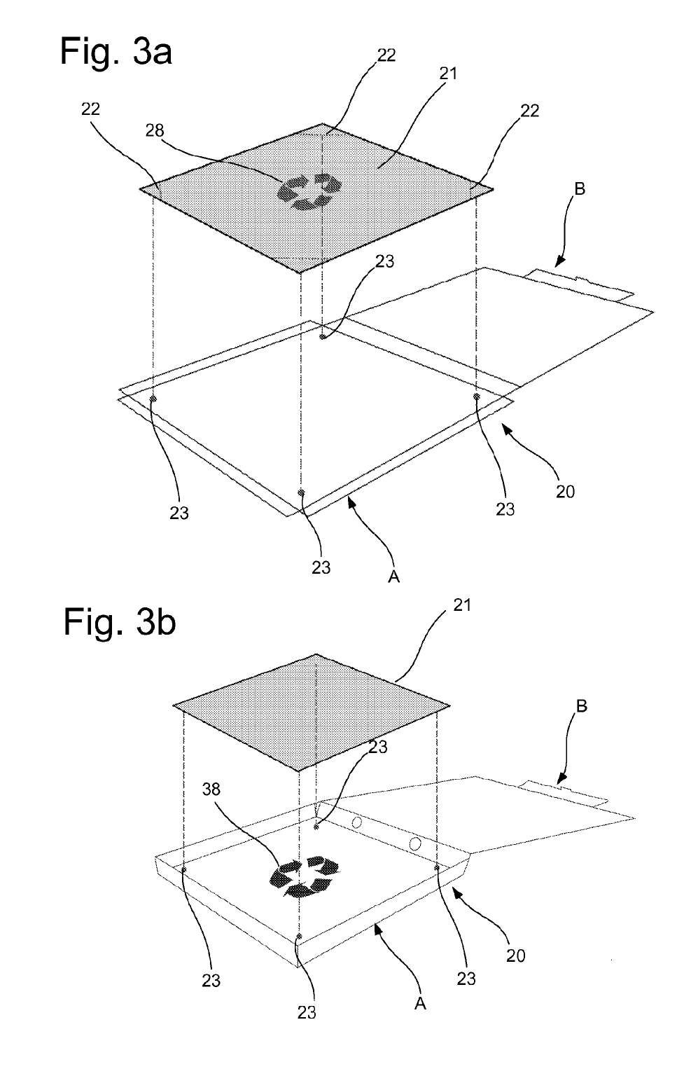

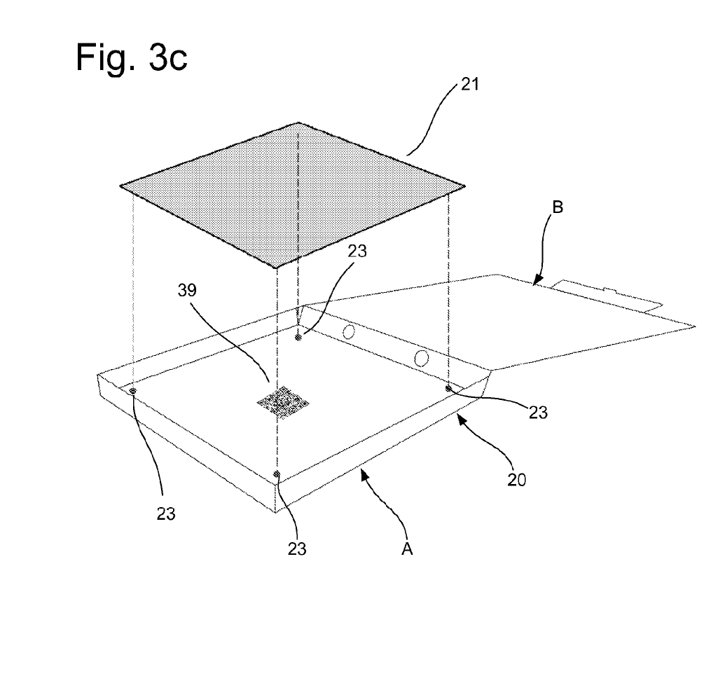

In FIG. 3a it is shown a perspective view of the cardboard (20), in which it is shown a sheet (21) with the projecting lines of the sheet (21) comprising possibly the perforated lines (22) with respect to the cardboard and the gluing points (16). In addition, it is shown the symbol (28) of the “recycle” which represents symbolically the presence of a message showing the features of the cardboard for the pizza according to the present invention and the instructions about the way to remove the sheet to facilitate the cardboard recycling. Said message, indicated symbolically by (28), can be conveniently printed on the rear side of the sheet (21), the side which is not in contact with the pizza, and which can be printed since it is free of silicon coating, which instead is provided on the upper side of the sheet in contact with the foodstuffs.

In FIG. 3b it is shown a box (20) in which it is shown a sign (38), ideally represented by the symbol “recycling”, which is printed directly on the cardboard in the side (A) in contact with the pizza. The baking paper sheet (21) covers said printing preventing the contact with the foodstuff, but it allows it to be read because the same sheet is semi-transparent.

In FIG. 3c the same box (20) has instead a printing of a QR Code (39) on the bottom. Said QR Code is printed in line during the production step of the cardboard by means of an ink-jet head associated to a computerized system which provides the QR Code. The QR Code can be used to provide fidelity or loyalty systems or information about the pizzeria which has produced the pizza or other marketing and communication initiatives. The consumer is therefore stimulated to remove the sheet, and to allow its recyclability, in order to find out the QR Code message.

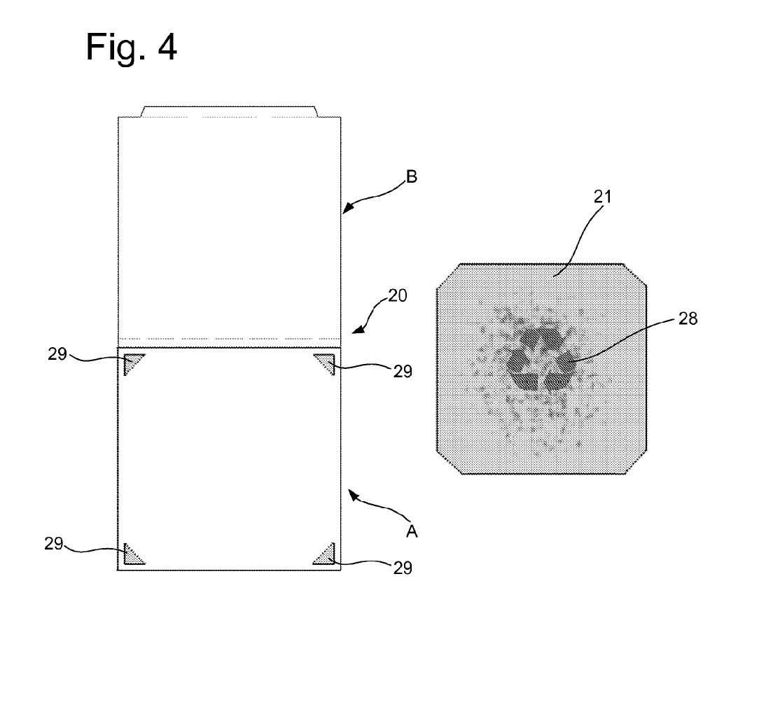

In FIG. 4 it is shown how, once the pizza is consumed and the sheet (21) removed from the perforated corners (29) by tearing it away, these remain in triangle shape at the corners of the bottom, i.e. of the side A of the cardboard (20), and this latter results clean and organic substances free, ready to be disposed in the containers for the paper to be recycled. Said organic residues are provided (shown as spots) on the sheet (21) which can be curled up and disposed in the undifferentiated waste. It is clear that in case there are no perforated lines (22) on the sheet (21), as it is shown in figure Ic, there will be no triangles (29) remaining on the cardboard once the same is used.

Advantageously the invention allows to recover the cardboard (10, 20) of the pizza to be recycled, without the organic residue contaminating the lot or the wastepaper stock, as it usually occurs. In fact the invention, by using a baking paper sheet allows to recover the whole pizza box. In fact, the weight of the sheet (21) of greaseproof paper having dimensions 30 cm×30 cm is about 4 g, which allow to recover a cardboard which weighs 80-100 g. Thus allowing therefore a paper recovery equal to more than 20 times the one used for the paraffined paper sheet required by the invention, with a clear ecological advantage. Moreover, the invention guarantees a more hygienic safety and usage of the product preventing the contact of portions of the pizza with the cardboard.

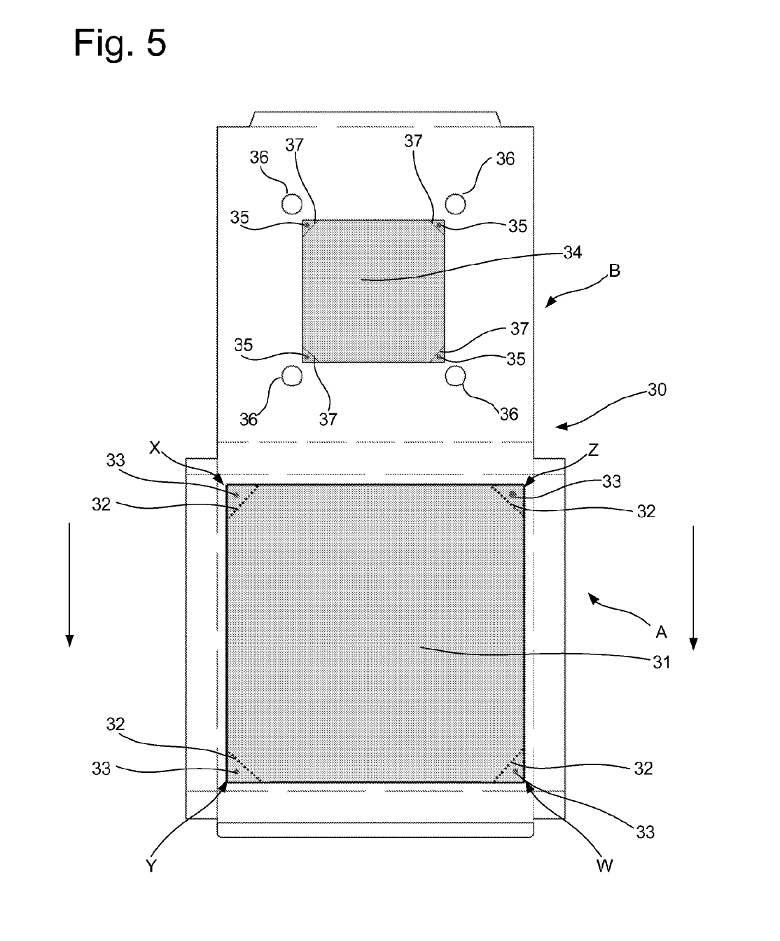

In FIG. 5 it is shown a third embodiment of the present invention which provides a cardboard (30) for pizza (shown in opened configuration), in which in addition to the first sheet (31) there is also a second sheet (34) of baking paper. Thanks to said second sheet (34), it is possible to prevent the contact of the central portion of the pizza with the upper side (B) of the cardboard (30), preventing that the mozzarella sticks to the cardboard. This can occur both because of the height of the pizza which increases proportionally to the increase in quantity of ingredients and condiments and because of the weight of the stacked pizzas, causing the central portion of the cardboard to be pressed and to adhere to the upper side of the pizza.

On the sheet (31) glued to the side A there are shown the gluing points (32) and the perforating lines (33), not strictly provided; on the sheet (34) glued to the side B by means of gluing points (35) there are also shown the respective perforating lines (37) possibly provided. The sheet (34) can have smaller dimensions and shape preferably similar to the one of sheet 31, and it is arranged so that the holes (36), possibly provided on the side (B) of the box (30), make the vapour released by the pizza go out when the cardboard is closed during the transport step. If there are no holes (36) the vapour will condense inside the box, thus causing fragrance and consistency loss of the pizza. As yet said, the invention can be realized also without perforation lines on both sheets (31, 34) which can be both tore away by lifting the corners as it is shown in fig. Ic.

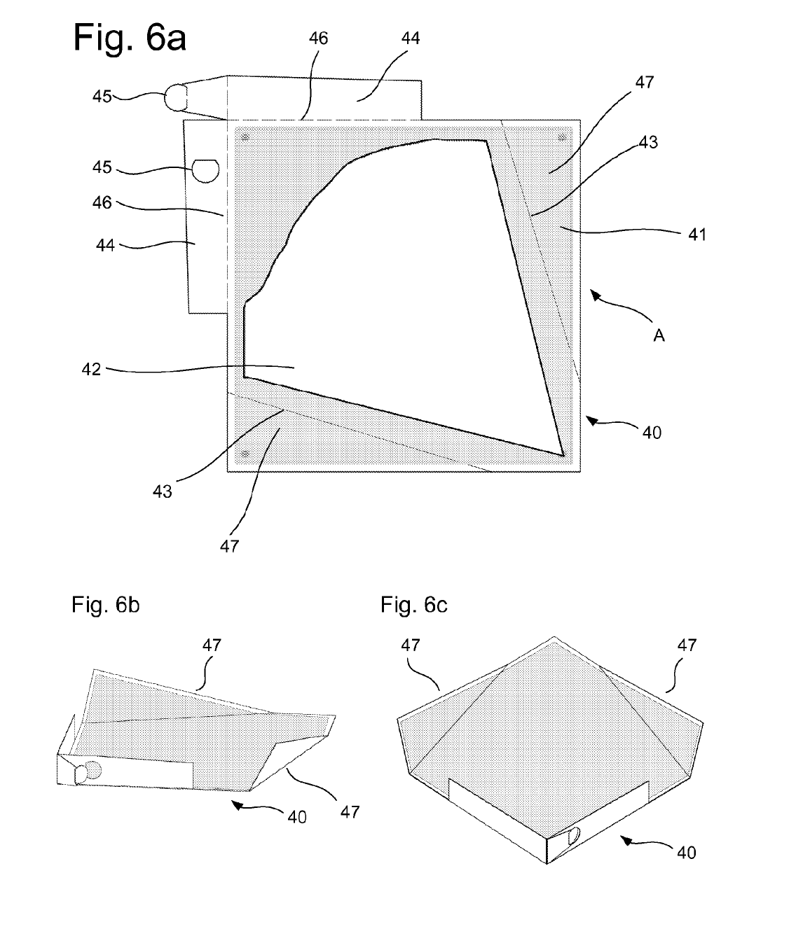

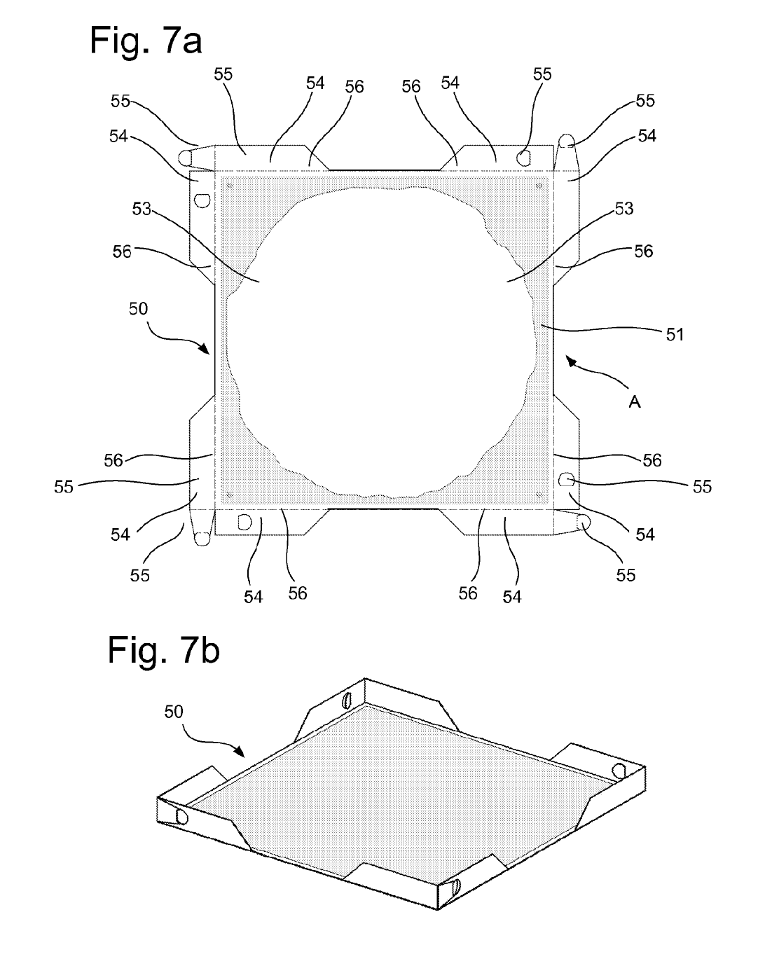

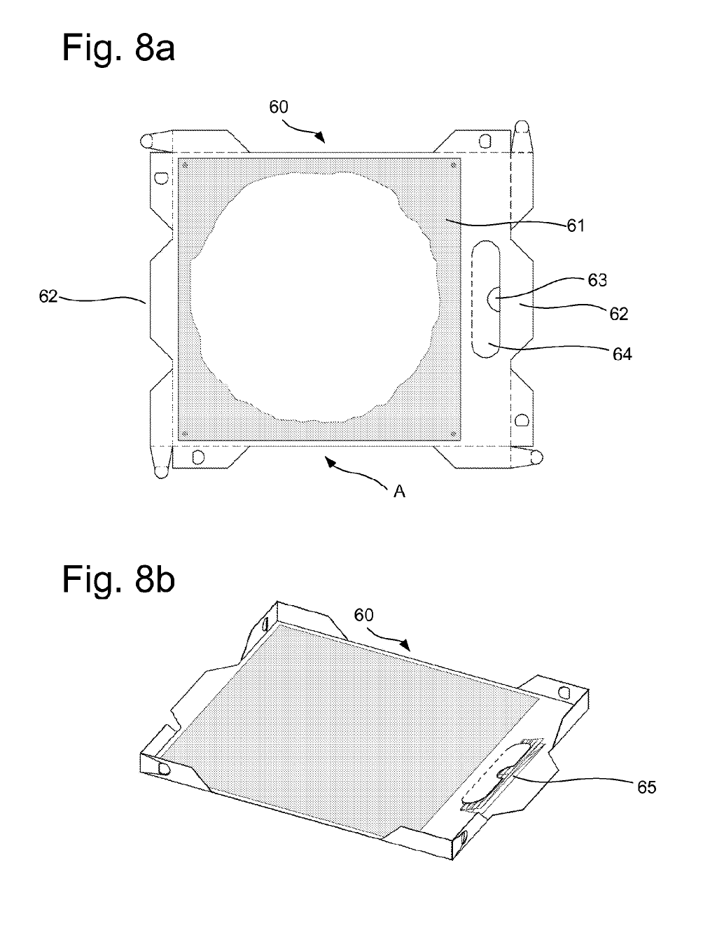

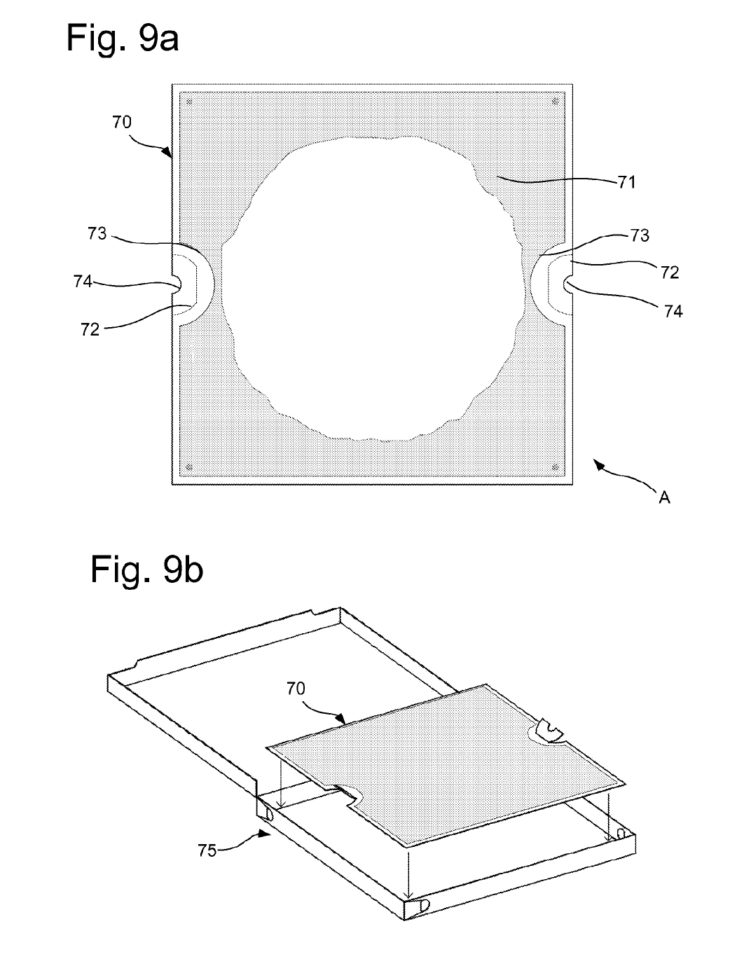

As yet said, the box can have various shapes without departing from the aims of the present invention. As a way of example there are shown:
in FIGS. 6a, 6b, 6c various views of an embodiment of the box particularly comfortable for the consumption of pizza slices;
in FIGS. 7a, 7b, 8a and 8b various views of an embodiment of the box particularly comfortable for the usage as a dish or tray;
in FIGS. 9a and 9b, another embodiment of the box particularly comfortable for the usage as a tray and mat for pizza in corrugated cardboard, which in turn can be introduced inside a pizza box.

These are only some example of embodiments of the box for foodstuffs, and in particular for pizza, according to the present invention, as defined in the appended claims.

In FIG. 6 it is shown a fourth embodiment of the present invention which consists of a box (40) for pizza slices (42) or focaccias of smaller dimension than the previous embodiments. Its aim is to allow the transport for small distances and the consumption of a slice of pizza (42) even on foot. In this embodiment, the box is obtained from a sheet (40) of corrugated cardboard which is provided with a corner of means (45) apt to fold and retain the flaps (44) of the cardboard, in order to obtain a raised angular edge which prevents the pizza from falling. In addition, on the cardboard there are provided folding or dashed lines (46) which separate the flaps (44) from the rest of the cardboard, facilitating the flaps (44) to be folded. Moreover, two raisable tongues (47), realized by means of other folding lines (43), prevent the pizza slice from sliding laterally. A sheet of baking paper (41) is glued substantially in the same way as the previous embodiments. In FIGS. 6b and 6c there are shown perspective views and of the assembled box, with the tongues (47) raised.

In FIG. 7a, it is represented a fifth embodiment of the invention of a box particularly comfortable to be used as a dish for the consumption of a whole pizza. Said box is shaped as a square (50) or rectangle (60) and is provided with four corners of flaps (54) which can be raised and mounted in order to obtain angular barriers apt to contain the pizza. Said flaps (54) are provided with folding or dashed lines (56) in order to make easier their raising and with restraining means (55) known in the art for their fixing. In this way, the box (50) is provided with protection corners to prevent the pizza from falling in case of an accidental fall or of the cardboard tilting. The absence of raised edges in the central portion on each side of the cardboard allows to lean the wrists to have a better access to the cardboard in order to obtain the features of usability of a dish, realized however in corrugated cardboard. It is clear that also in this embodiment it is provided a baking paper sheet (51) glued substantially in the same way as what yet described.

In FIG. 7b it is shown a perspective view of such box, which can also have a rectangular shape as it is shown in FIG. 8a, where the box (60) has the shape of a tray and comprises handles (62) obtained by means of suitable dinking of the cardboard and a sheet of baking paper (61) removable according to what yet described. Along a side of the box (60) by means as cutting and folding lines it can be possibly obtained a slot (63) apt to raise a napkin stop (64) in order to provide a space where to introduce napkins (65) or other objects as plastic cutlery or bags containing cutlery, as it is shown in FIG. 8b.

In FIG. 9a it is shown a sixth embodiment of the invention. In order to provide a flat tray without raisable edges, it is used an corrugated cardboard sheet (70) to which it is glued a sheet (71) of baking paper according to what yet described. Said cardboard sheet (70) is provided on the sides in central position with folds and notches apt to obtain raising handles (72) with a recess (64) in order to allow the cardboard sheet (70) to be raised and its introduction inside the pizza box (75). The sheet (70) can be simply leaned inside the box (75). Also the baking paper sheet (71) has a recess (73) on both sides at the flaps (72) obtained by means of dinking of the sheet (71) in the production step of the same. The dimensions of the sheet (70) are proportioned to the box (75) in which it can be introduced, shown in FIG. 9b. In this way, it is possible the consumption outside the box, as it is a dish, by raising the box (70) in order to allow the recycling both of the box (75) for the transport and of the corrugated cardboard sheet (70) once the baking paper sheet (71) is removed. The usage of the box (70) improves the hygienic standards of the box and allows to prevent that the box is dirtied in presence of very-stuffed and very oily pizzas.

In order to produce a box according to the present invention, there can be used production lines known in the state of the art used in box factories regarding the portion relative to the cardboard, while in order to implement the additional features of the present invention, there can be used techniques known in the paper field. Actually, the invention can be simply industrialized, adding the respective process steps to the yet existing production lines, in order to realize the pizza box according to the present invention. The realization of the present invention begins starting from the cardboard yet realized in spread shape which goes out from the production line and is destined to be packaged in packs by means of cellophane or other retaining system.

Therefore the implementation of the present invention is downstream of the production line and the introduction of equipments to realize the present invention is simple and does not modify the production sequence, but adds simply at the end the required steps.

The production steps to produce the present invention on industrial scale, to be added to the processes known at the state of the art and in the industrial technique of the cardboard box are:
a) (possible) perforating the baking, paraffined or greaseproof paper sheet;
b) applying the glue on the pizza cardboard;
c) coupling;
   the step a), which possibly cannot be provided, consists in the operation of perforation of the sheet, to provide perforated lines in the paper at the gluing points in order to allow the sheet to be tore away in an easier way after the consumption of the pizza. The operation of sheet perforation can be off-line and on-line. Off-line means that said sheet perforation can be realized by using specific equipments for perforating off the production line of the pizza cardboards. The sheets are perforated according to the known technique and the sheets stacked thus perforated are then used to be arranged on the cardboard. The online production instead provides that the perforation step is carried out in the production line using means apt to perforate the sheet or directly a baking or paraffined paper web coming from a paper reel. When it is used a paper reel, there are required means apt to cut the sheets, with preferable and compatible dimensions to the dimensions of the side A of the pizza cardboard. In the step “b”, the application of the glue on the cardboard begins when the pizza cardboard arrives from the production line on a conveyor belt and passes in a machine inside which there are two or more feeding systems of the suitable glue with micro-nozzles able to inject the glue quantity required to guarantee that the corners are well glued, i.e. the application of the glue points. Said feeding gun, controlled by a computerized system, are arranged at a distance suitable to guarantee the glue application so that each gun can feed the glue to the required points.

Step “c” : the coupling of the sheet provides that the greaseproof or paraffined paper sheet coming from a pile of sheets or from a reel is coupled to the cardboard by means of cylinders and means known in the paper industry. When the sheets come from a reel, there will be means apt to cut the sheets before the coupling step.

Said production process can be realized and implemented with means different and known in the art, as it is clear for those skilled in the art, as well as the choice of the materials (glues, paper), of the presence and the type of perforation (points or dashes), of the gluing points can vary without impairing the effectiveness of the present invention. In addition, it is clear that the present invention can be adapted to boxes for pizza realized with other materials as plastic, having a suitable shape for the transport of pizza and that have the same recyclability problems i.e. contamination from organic substances, as the residues connected to the pizza consumption directly in the box.

According to an alternative process, the cited steps b) and c) can be possibly replaced by the following steps:
b) application of the glue on the pizza box
c) application of the sheet on the cardboard
   and also the step of:
d) pressing/stretching
   in detail: in the hypothesis that the steps b, c and d are realized, it is used a machine, which inside has means apt to realize the various production steps or the operations to be carried out.

### Step b) Application of the Glue on the Pizza Cardboard

The cardboard of the pizza arrives to the production line on a conveyor belt and it passes in a machine inside which there are two gun feeding systems of hot or spray glue with micro-nozzles apt to inject the glue quantity required to guarantee that the corners are well glued. Said feeding guns, controlled by a computerized systems, are arranged on the two long sides with respect to the conveyor belt at a distance suitable to guarantee the application of glue in the desired points. Thanks to the provision of guns, in this way on the cardboard there will be applied 4 drops of glue on the four corners, and so it is possible to go to the following step.

### Step c) Application of the Sheet on the Cardboard

Once the the step b is ended, the conveyor belt makes the cardboard go forward in a following production step, where the means allow the application of a paper sheet, by means of a system of mechanisms apt to move a mechanical arm with vacuum suckers which takes a sheet from a feeder arranged in parallel position to the conveyor belt of the machine, and releases it at the side of the cardboard on which it is to be applied. In alternative to the ream system or to the yet cut sheets feeder, it is possible to use a feeding system based on a baking or greaseproof or paraffined paper reel in which a reel arranged on the top feeds a system of cylinders which transport the paper web from the reel to the application, and by using means known in the art allow to lean the sheet on the cardboard; in this case at the releasing means of the sheet there is a cutter which actuated cuts automatically the sheet at the desired length of the cardboard form.

### Step d) Pressing

Once the sheet is applied on the cardboard, whether this step is carried out by means of a sheet feeding system or by means of a reel, there is the pressing step in which one or more cylinders (also heated) arranged after the systems of steps c, press the sheet on the cardboard making it adhere to the glue points and to be well stretched on the cardboard.

Moreover it is clear to those skilled in the art how it is possible to realize the aim of the present invention using other solutions regarding the paper and the adherence to the sheet without impairing the effectiveness of the present invention.

1. Box for bakery foodstuffs made with recyclable material comprising at least a sheet of greaseproof material and suitable to come in contact with foodstuffs, said sheet being constrained to the portion of said box on which said bakery foodstuffs are leaned by means of one or more gluing points such that it can be tore away manually.

2. Box for bakery foodstuffs according to claim 1, wherein said box for bakery foodstuff is made with corrugated cardboard.

3. Box for bakery foodstuffs according to claim 1, wherein said sheet of greaseproof material and suitable to come in contact with foodstuffs is made of oiled paper, siliconed baking paper on one or both the surfaces or paraffined paper and it is glued to said box by means of nontoxic material and suitable for foodstuffs packaging glues.

4. Box for bakery foodstuffs according to claim 1, wherein the shape of said box is square or rectangular, the height of said box is such that it can house a pizza and the shape of said sheet of greaseproof material is square, rectangular or circular.

5. Box for bakery foodstuffs according to claim 1, wherein said sheet of greaseproof material is glued to said box by means of application of low adherence glue in a series of points arranged preferably at the corners of said sheet.

6. Box for bakery foodstuffs according to claim 1, wherein said box comprises at least a first side which defines the base of said box on which said bakery foodstuffs can be leaned and can comprise a second side which defines the cover of said box.

7. Box for bakery foodstuffs according to claim 1, wherein said box further comprises a second sheet of greaseproof material glued in the same way as the first sheet of greaseproof material to said second side which defines the cover of the box, on the side facing the bakery foodstuff.

8. Box for bakery foodstuffs according to claim 7, wherein said one or both sheets of greaseproof material comprise perforations apt to facilitate its tearing away.

9. Box for bakery foodstuffs according to claim 7, wherein said sheet of greaseproof material has printed texts or symbols, on its lower side, apt to give instructions about the recycling of the product or other information.

10. Box for bakery foodstuffs according to claim 1, wherein said box has printed texts or symbols on the side where the sheet of greaseproof material is applied; said printed texts or symbols are apt to give instruction about the recycling of the product or a QR Code.

11. Box for bakery foodstuffs according to claim 1, is suitable to be used for the consumption of slices of pizza, provided with raisable flaps on one or more sides.

12. Box for bakery foodstuffs according to claim 1, wherein said box is provided with raisable flaps and with means for facilitating their raising at each corner; and wherein said box is without a closing cover.

13. Box for bakery foodstuffs according to claim 1, further comprising raisable flaps to obtain handles apt to allow the box to be raised.

14. Method for the production of a box for bakery foodstuffs using corrugated cardboard for bakery foodstuffs provided with a detachable sheet comprising the steps of:
a. providing perforations on a sheet of greaseproof material to define weakening or tearing away lines on the same sheet;
b. applying glue material on the bottom of the cardboard box for bakery foodstuffs;
c. coupling said sheet of greaseproof sheet to the bottom of said box to fix said sheet to said box.

15. Method according to claim 14, further comprising the pressing step of said sheet on the bottom of said box.
